(19) United States
(12) Patent Application Publication
(10) Pub. No.: US 2023/0307954 A1
(43) Pub. Date: Sep. 28, 2023

(54) WIRELESS POWER TRANSMISSION DEVICE

(71) Applicant: TDK CORPORATION, Tokyo (JP)

(72) Inventors: Michihisa Tokui, Tokyo (JP); Takuya Yoshida, Tokyo (JP)

(73) Assignee: TDK CORPORATION, Tokyo (JP)

(21) Appl. No.: 18/125,548

(22) Filed: Mar. 23, 2023

(30) Foreign Application Priority Data
Mar. 25, 2022 (JP) 2022-049248

(51) Int. Cl. H02J 50/10; H02J 50/00; H02J 50/40; H01F 27/28

(52) U.S. Cl. CPC H02J 50/10; H02J 50/005; H02J 50/402; H01F 27/2804; H01F 2027/2809

(57) ABSTRACT

A wireless power transmission device is provided with a coil unit having first and second main surfaces and configured to be movable between a first position as a laid position of the first main surface and a second position as an erected position of the first main surface, a first coil housed in the coil unit so as to face the first main surface, and a first support member having a facing surface disposed separated from the first main surface by a first distance when the coil unit is at the second position.

### CROSS-REFERENCE TO RELATED APPLICATION

This application claims the benefit of Japanese Patent Application No. 2022-049248, filed on Mar. 25, 2022, the entire disclosure of which is incorporated by reference herein.

### BACKGROUND

The present disclosure relates to a wireless power transmission device.

A wireless charger is known as a charger for charging a battery of a mobile device such as a smartphone. The wireless charger can charge an electronic device without cable connection, so that a use enjoy much convenience.

As for such a wireless charger, JP 2018-075875A describes that a portable electronic device is charged by a noncontact power feeder housed in a holder for holding the electronic device. The electronic device is charged in a so-called flatbed position. Further, J P 2021-013292A describes a wireless charger capable of efficiently charging a plurality of user terminals using a tilt function at a portion where the user terminals are installed.

JP 2013-158148A describes a charger capable of charging two electronic devices simultaneously through noncontact power feeding utilizing electromagnetic induction. This charger has two housing parts formed in a cabinet of a charging base. Two portable electronic devices are housed in the two respective housing parts, and reception coils of the respective portable electronic devices are disposed facing each other across a power feeding coil.

WO 2018/092569 A1 describes an electronic device having a configuration in which a first body incorporating a first coil antenna and a display and a second body incorporating a second coil antenna are connected to each other through a hinge part, and a metal layer is interposed between the first and second coil antennas when the first and second bodies are made to overlap each other.

JP 2015-121377A describes a so-called dual-coil type power transmission coil unit including a first spiral coil formed on a first surface of a multilayer substrate, a second spiral coil formed on a second surface on the opposite side of the first surface, and a layer with a large dielectric loss tangent provided between the first and second spiral coils.

With the recent spread of battery mounting devices including smartphones, many users own a plurality of devices to be charged. Further, various charging forms are required (charging in a vertical position, charging in a flatbed position, etc.) according to the use purpose during charging. Under such circumstances, there is required a multifunctional wireless power transmission device capable of meeting such various needs.

### SUMMARY

A wireless power transmission device according to one embodiment of the present disclosure includes a coil unit, a first coil, and a first support member. The coil unit has first and second main surfaces and configured to be movable between a first position as a laid position of the first main surface and a second position as an erected position of the first main surface. The first coil is housed in the coil unit so as to face the first main surface. The first support member has a facing surface disposed separated from the first main surface by a first distance when the coil unit is at the second position.

### BRIEF DESCRIPTION OF THE DRAWINGS

FIG. 1 is a schematic perspective view illustrating the configuration of a wireless power transmission device according to one embodiment of the present disclosure, and specifically showing a state where a coil unit is in a laid position.

FIG. 2 is a schematic perspective view illustrating the configuration of a wireless power transmission device according to one embodiment of the present disclosure, and specifically showing a state where the coil unit is in an erected position.

FIG. 3 is a schematic cross-sectional view illustrating the configuration of the coil unit 20.

FIG. 4 is a schematic cross-sectional side view of the wireless power transmission device and illustrates a state where the coil unit is in the laid position.

FIG. 5 is a schematic cross-sectional side view of the wireless power transmission device and illustrates a state where the coil unit is in the erected position.

FIG. 6 is a schematic diagram illustrating setting positions of the magnets.

FIG. 7 is a schematic cross-sectional side view illustrating a modification of the first and second support members.

### DETAILED DESCRIPTION OF THE EMBODIMENTS

An object of the present disclosure to provide a highly convenient wireless power transmission device capable of simultaneously charging a plurality of devices to be charged and responding to both charging in a flatbed position and charging in a vertical position.

Hereinafter, preferred embodiments of the present disclosure will be described in detail with reference to the accompanying drawings.

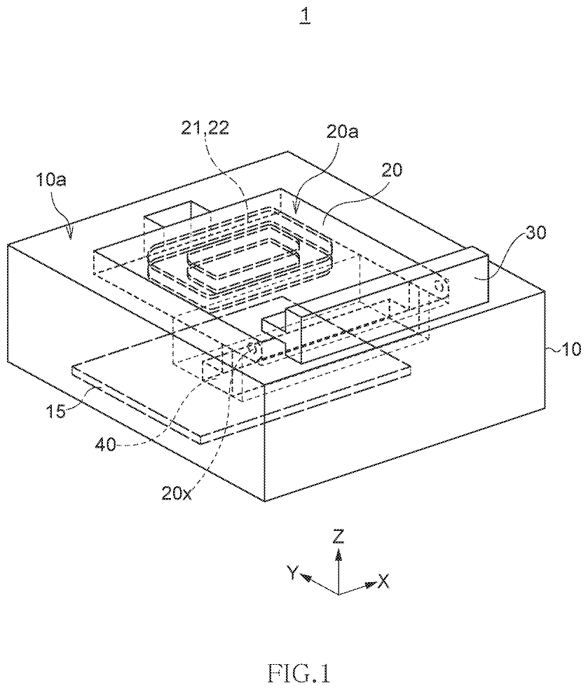

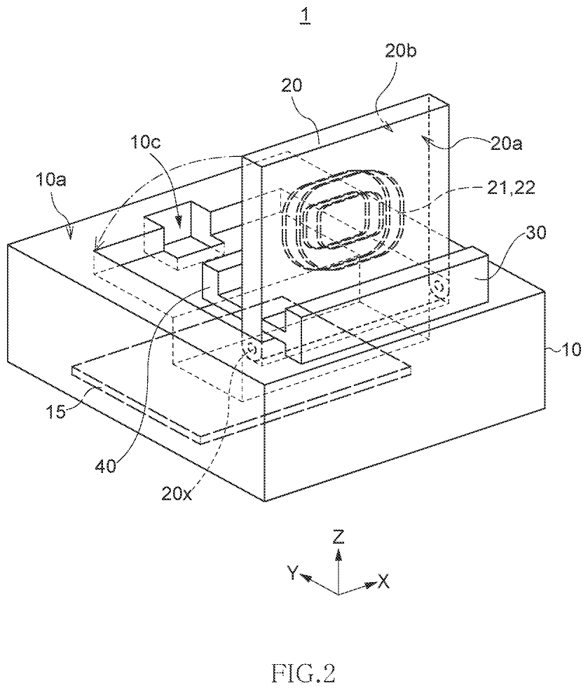

FIGS. 1 and 2 are schematic perspective views illustrating the configuration of a wireless power transmission device according to one embodiment of the present disclosure. FIG. 1 illustrates a state where a coil unit is in a laid position, and FIG. 2 illustrates a state where the coil unit is in an erected position.

As illustrated in FIGS. 1 and 2, a wireless power transmission device 1 according to the present embodiment includes a device body 10 and a coil unit 20 freely turnably provided with respect to the device body 10. The coil unit incorporates a planar loop coil (power transmission coil) for wireless power feeding, and the device body 10 houses therein elements (e.g., a drive circuit 15 for the power transmission coil) required to constitute the wireless power transmission device 1, excluding the power transmission coil.

The coil unit 20 is a plate-like movable member having an almost rectangular shape. The coil unit 20 is axially supported at its one end portion (base end) in the width direction perpendicular to the longitudinal direction by a turning support shaft 20x and can thereby turn about the turning support shaft 20x. That is, the coil unit 20 is configured to be foldable with respect to the device body 10.

In a state where the coil unit 20 is in a folded state (in the laid position) as illustrated in FIG. 1, the coil unit 20 is housed in a housing space 10c (cavity) provided in an upper surface 10a of the device body 10. In this state, one main surface (first main surface 20a) of the coil unit 20 is flush with the upper surface 10a of the device body 10. When the coil unit 20 is in the laid position, it is possible to charge a device to be charged such as a smartphone on the first main surface 20a of the coil unit 20 in a flatbed position. When the device body 10 is installed such that the upper surface 10a thereof is parallel to a horizontal plane, the laid position of the coil unit 20 is a horizontal position.

On the other hand, when the end portion of the coil unit is lifted from the laid position (first position) illustrated in FIG. 1, the coil unit 20 turns by 90° about the turning support shaft 20x to assume the erected position (second position), as illustrated in FIG. 2. When the coil unit 20 is in the erected position, wireless charging can be performed in a state where a device to be charged is in a vertical position. The erected position of the coil unit 20 need not strictly be vertical but may be slightly tilted. However, when double-sided charging is performed, the coil unit 20 is preferably not tilted.

Although details will be described later, a first support member 30 is provided on the upper surface 10a of the device body 10. When a device to be charged is put in the vertical position on the first main surface 20a side in a state where the coil unit 20 is in the erected position, the first support member 30 holds the device to be charged. The first support member 30 is disposed close to the end portion of the coil unit 20 on the side opposite to the housing space 10c of the coil unit 20 with respect to the turning support shaft 20x.

Further, a second support member 40 is provided on a second main surface 20b of the coil unit 20. The second main surface 20b is the surface opposite to the first main surface 20a. When a device to be charged is put in the vertical position on the second main surface 20b side in a state where the coil unit 20 is in the erected position, the second support member 40 holds the device to be charged. Unlike the first support member 30, the second support member 40 is fixed to the coil unit 20, so that it turns together with the coil unit 20, that is, when the coil unit 20 is in the laid position, the second support member 40 is housed in the housing space 10c. As described above, the second support member 40 moves in conjunction with the coil unit 20.

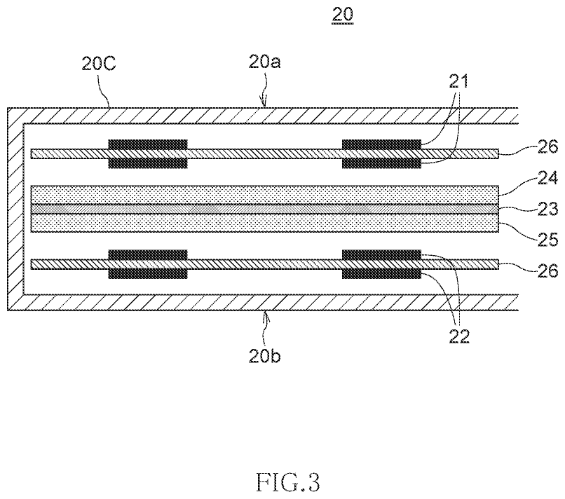

FIG. 3 is a schematic cross-sectional view illustrating the configuration of the coil unit 20.

As illustrated in FIG. 3, the coil unit 20 includes a thin coil case 20C having the first and second main surfaces 20a and 20b, a first coil 21 housed in the coil case 20C so as to face the first main surface 20a, a second coil 22 housed in the coil case 20C so as to face the second main surface 20b, a conductor sheet 23 provided between the first and second coils 21 and 22, a first magnetic sheet 24 provided between the first coil 21 and the conductor sheet 23, and a second magnetic sheet 25 provided between the second coil 22 and the conductor sheet 23. Although the first and second coils 21 and 22 have substantially the same shape and size in the present embodiment, they may differ from each other in shape and size.

The first coil 21 serves as a power transmission coil used for charging a device to be charged put on the first main surface 20a side of the coil unit 20. Thus, the first coil 21 is used both when the coil unit 20 is in the laid position and when it is in the erected position.

The second coil 22 serves as a power transmission coil used for charging a device to be charged put on the second main surface 20b side of the coil unit 20. Thus, the second coil 22 is used only when the coil unit 20 is in the erected position and not used when it is in the laid position. When the coil unit 20 is in the laid position, the second coil 22 is housed in the housing space 10c.

The conductor sheet 23 is provided between the first and second coils 21 and 22, so that it is possible to prevent mutual interference between the first and second coils 21 and 22 to thereby achieve stable charging of a plurality of devices to be charged. Further, the first magnetic sheet 24 that forms a magnetic path for magnetic flux generated from the first coil 21 is provided between the first coil 21 and the conductor sheet 23, and the second magnetic sheet 25 that forms a magnetic path for magnetic flux generated from the second coil 22 is provided between the second coil 22 and the conductor sheet 23, whereby charging efficiency can be improved.

In the present embodiment, the first and second coils 21 and 22 each include two series-connected planar coil patterns on the respective front and back surfaces of a substrate 26 to constitute a single coil. The planar coil patterns are each a conductor pattern made of a good conductor such as copper and wound in a plurality of turns in a planar shape around the coil axis. For example, the two planar coil patterns on the respective front and back surfaces of the substrate 26 are connected to each other at the inner peripheral ends. However, the first and second coils 21 and 22 may each include a single planar coil pattern. With this configuration, a very thin coil having large inductance can be achieved. The substrate 26 is not particularly limited in material and may be made of a transparent or translucent flexible insulating material such as PET (Polyethylene Terephthalate) resin. Alternatively, the substrate 26 may be a flexible substrate obtained by impregnating glass cloth with epoxy-based resin.

More specifically, the first and second coils 21 and 22 are each constituted by a planar loop coil (planar coil) having a roughly oval or elliptic shape with different dimensions in the vertical and horizontal directions in a plan view. The major axis direction of the planer loop coil is parallel to the extending direction (X-direction) of the turning support shaft 20x of the coil unit 20. That is, the first and second coils 21 and 22 are each housed in the coil case 20C such that the longitudinal direction thereof is perpendicular to the normal direction of the first and second main surfaces 20a and 20b and is directed to a direction perpendicular to the erected direction in a state where the coil unit 20 is in the erected position. The first and second coils 21 and 22 may each have a shape with different dimensions in the vertical and horizontal directions in a plan view, other than the oval or elliptic shape. The vertical dimension of each of the first and second coils 21 and 22 is defined as the dimension thereof in the vertical direction (erected direction) when the coil unit 20 is in the erected position, and the horizontal dimension of each of the first and second coils 21 and 22 is defined as the dimension thereof in a direction perpendicular to the erected direction, i.e., in the horizontal direction when the coil unit 20 is in the erected position.

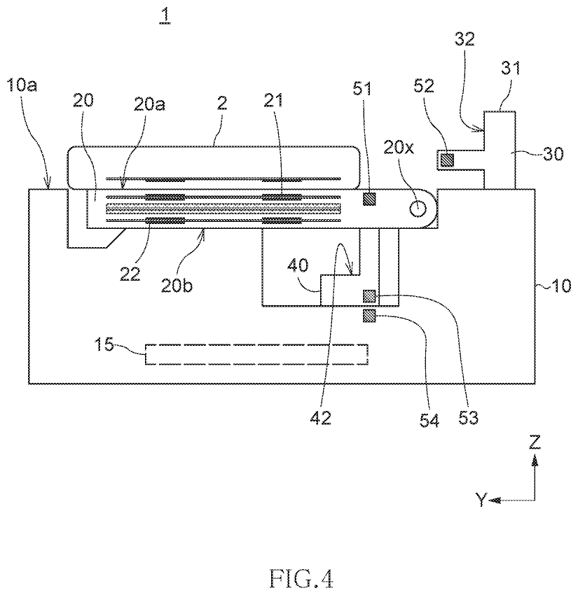

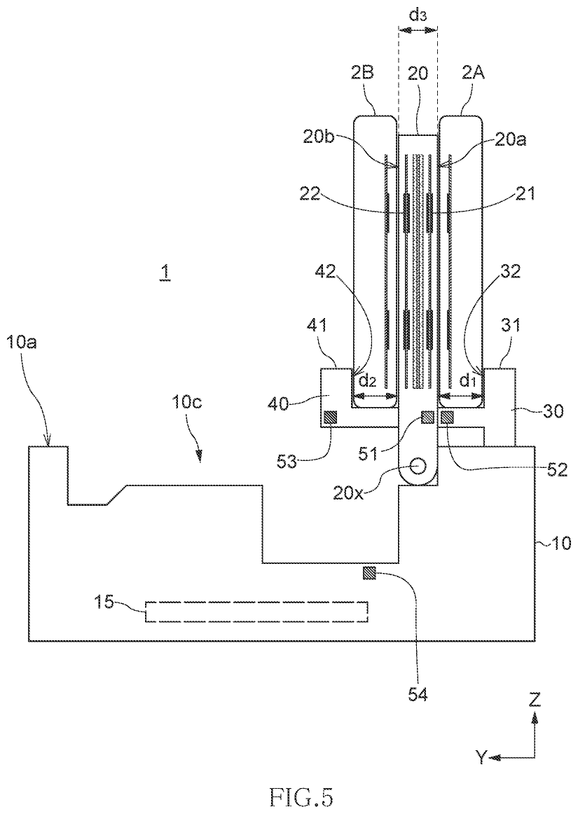

FIGS. 4 and 5 are schematic cross-sectional side views of the wireless power transmission device. FIG. 4 illustrates a state where the coil unit is in the laid position, and FIG. 5 illustrates a state where the coil unit is in the erected position.

As illustrated in FIGS. 4 and 5, the base end of the coil case 20C of the coil unit 20 is axially supported on the device body 10, whereby the coil unit 20 can be freely turned about the turning support shaft 20x. As illustrated in FIG. 4, when the coil unit is in the laid position, the first main surface 20a of the coil unit 20 is flush with the upper surface 10a of the device body 10, and thus a device 2 to be charged, such as a smartphone, can be charged in a state where it is put in the flatbed position on the first main surface 20a of the coil unit 20.

The first support member 30 is vertically installed on the upper surface 10a of the device body 10. The first support member 30 is disposed on the side opposite to the housing space 10c of the coil unit 20 with respect to the turning support shaft 20x of the coil unit 20 and close to the outer peripheral end of the device body 10. Thus, in a state where the coil unit 20 is in the erected position, the height of the center position of the first coil 21 is higher than the height of a leading end engagement part 31 of the first support member in the erected direction. As a result, when a device 2A to be charged is set in the first support member 30, the center thereof is brought close to the center of the first coil 21, so that it is possible to perform efficient charging while stably holding the device 2A to be charged.

The leading end engagement part 31 of the first support member 30 has a facing surface 32 separated from the first main surface 20a by a predetermined distance d₁ (first distance) when the coil unit 20 is in the erected position and thereby holds the side end portion of the device 2A to be charged between itself and the first main surface 20a. This maintains the erected position of the device 2A to be charged placed on the first main surface 20a side of the coil unit 20. As an alternative, the lower end portion of the device 2A to be charged may be held between the first support member 30 and the first main surface 20a of the coil unit 20.

In the present embodiment, the first coil 21 is housed in the coil case 20C such that the longitudinal direction thereof is perpendicular to the normal direction of the first and second main surfaces 20a and 20b and is directed to a direction perpendicular to the erected direction in a state where the coil unit 20 is in the erected position. Thus, in a configuration where the side end portion of the device 2A to be charged is held, reduction in charging efficiency can be suppressed even if the device 2A to be charged shifts in position in the extending direction (X-direction) of the turning support shaft 20x of the coil unit 20.

Although the leading end engagement part 31 of the first support member 30 has a portion that protrudes toward the first main surface 20a of the coil unit 20 in the present embodiment, but this configuration is not essential. That is, the device 2A to be charged may be held between the first support member and the first main surface 20a of the coil unit 20 with the side end or lower end portion of the device 2A to be charged contacting the upper surface 10a of the device body 10. Further, when the wireless power transmission device 1 is provided in a console box of a vehicle, the first support member 30 may be constituted by an inner wall of the console box.

In the present embodiment, a magnet 51 (first magnet) is provided on the first main surface 20a side of the coil unit 20, and a magnet 52 (second magnet) corresponding to the magnet 51 is provided in the first support member 30. The magnet 52 is disposed at a position opposite to the magnet 51 in a state where the coil unit 20 is in the erected position, thus generating attraction force between the magnets 51 and 52, which can make the erected position of the coil unit 20 stable.

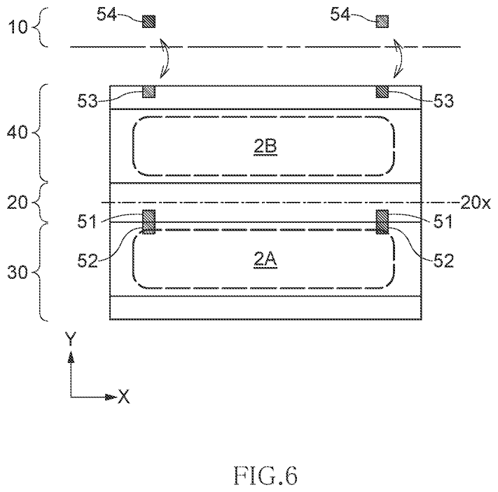

As illustrated in FIG. 6, a plurality of the magnets 51 may be provided in the coil unit 20 and disposed at both the left and right positions of the coil case 20C which are closer to both end portions thereof in the width direction (X-direction) than to the center in the same direction. More specifically, the magnets 51 are disposed close to both end sides of the coil case 20C in a direction perpendicular to the normal direction of the first and second main surfaces 20a and 20b of the coil unit 20 and in a direction perpendicular to the erected direction in a state where the coil unit 20 is in the erected position than to the center of the coil case 20C in the same direction. The magnets 52 of the same number as the number of the magnets 51 may be provided at positions in the first support member 30 that are opposite to the magnets 51. In the present embodiment, two pairs of magnets 51 and 52 are respectively provided in the vicinity of one end portion and the other end portion of the coil case 20C in the width direction.

The second support member 40 is provided on the second main surface 20b of the coil unit 20. The second support member 40 is disposed closer to the turning support shaft 20x than to the center of the coil unit 20. Thus, in a state where the coil unit 20 is in the erected position, the height of the center position of the second coil 22 is higher than the height of a leading end engagement part 41 of the second support member 40 in the erected direction. As a result, when a device 2B to be charged is set in the second support member 40, the center thereof is brought close to the center of the second coil 22, so that it is possible to perform efficient charging while stably holding the device 2B to be charged.

The leading end engagement part 41 of the second support member 40 has a facing surface 42 separated from the second main surface 20b by a predetermined distance d₂ (second distance) when the coil unit 20 is in the erected position and thereby holds the side end portion of the device 2B to be charged between itself and the second main surface 20b. This maintains the erected position of the device 2B to be charged placed on the second main surface 20b side of the coil unit 20. As an alternative, the lower end portion of the device 2B to be charged may be held between the second support member 40 and the second main surface 20b of the coil unit 20.

In the present embodiment, a magnet 53 (third magnet) is provided on the second main surface 20b side of the coil unit 20, and a magnet 54 (fourth magnet) corresponding to the magnet 53 is provided in the device body 10. The magnet 53 may be disposed at the end surface of the second support member 40, and the magnet 54 is disposed at a position opposite to the magnet 53 in a state where the coil unit 20 is in the laid position. The magnets 53 and 54 may be disposed with polarities attracting each other or with polarities repelling each other. In the former case, it is possible to make the laid position stable and to prevent unintended erection of the coil unit 20, thus stabilizing a state where the coil unit is folded. In the latter case, repelling force is generated between the magnets 53 and 54 when the coil unit is in the laid position to thereby achieve smooth erection of the coil unit 20 from the device body 10. Further, in the latter case, repelling force is generated between the magnets 53 and 54 during the operation of folding the coil unit 20 from the erected position to the laid position to thereby prevent damage of the coil unit 20 due to contact with the device body 10.

As illustrated in FIG. 6, a plurality of the magnets 53 may be provided in the coil unit 20 and disposed at both the left and right positions of the second support member 40 which are closer to both end portions thereof in the width direction (X-direction) than to the center in the same direction. More specifically, the magnets 53 are disposed close to both end sides of the second support member 40 in a direction perpendicular to the normal direction of the first and second main surfaces 20a and 20b of the coil unit 20 and in a direction perpendicular to the erected direction in a state where the coil unit 20 is in the erected position than to the center of the second support member 40 in the same direction. The magnets 54 of the same number as the number of the magnets 53 may be provided at positions in the device body 10. In the present embodiment, two pairs of magnets 53 and 54 are respectively provided in the vicinity of one end portion and the other end portion of the second support member in the width direction.

In the present embodiment, the coil case 20C is very small in thickness. Thus, a distance d₃ between the first and second main surfaces 20a and 20b of the coil case 20C may be smaller than the first distance d₁ between the first main surface 20a and the first support member 30 and the second distance d₂ between the second main surface 20b and the second support member 40. This can reduce the size and weight of the movable part of the coil case 20C.

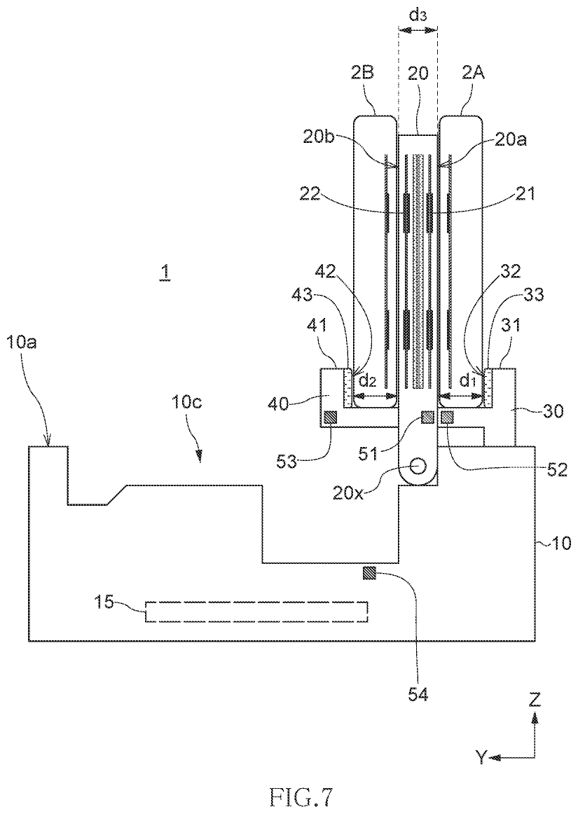

FIG. 7 is a schematic cross-sectional side view illustrating a modification of the first and second support members 30 and 40. As illustrated, the first and second support members 30 and 40 may each have a part (e.g., facing surface 32, 42) that is made of an elastic member (33, 43) such as rubber, and the first and second distances d₁ and d₂ may be made variable by the elastic deformation of the elastic member. By thus using a flexible material for the first and second support members 30 and 40, it is possible to respond to various devices to be charged of different thicknesses to thereby perform stable and efficient charging without involving a change in the transmitting/receiving distance.

As described above, the wireless power transmission device 1 according to the present embodiment includes the device body 10 and the coil unit 20 freely turnably provided with respect to the device body 10. The coil unit 20 has the first and second main surfaces 20a and 20b and configured to be movable between the first position as the laid position of the first main surface 20a and the second position as the erected position of the first main surface 20a. The coil unit houses therein the first coil 21 facing the first main surface 20a and the second coil 22 facing the second main surface 20b, and the device body 10 has the first support member 30 disposed separated from the first main surface 20a by the predetermined first distance d₁ when the coil unit 20 is at the second position. With this configuration, there can be achieved a highly convenient wireless power transmission device capable of responding to both charging in a flatbed position and charging in a vertical position.

Further, the wireless power transmission device 1 according to the present embodiment has the second support member 40 which is fixed to the coil unit 20 so as to be disposed separated from the second main surface 20b by the predetermined second distance d₂ when the coil unit 20 is at the second position. Thus, it is possible to perform double-sided charging in which, in a state where the coil unit is at the second position, two devices to be charged are vertically set on the respective sides of the first and second main surfaces 20a and 20b and charged simultaneously.

While the preferred embodiment of the present disclosure have been described, the present disclosure is not limited to the above embodiment, and various modifications may be made within the scope of the present disclosure, and all such modifications are included in the present disclosure.

For example, although the coil unit 20 is provided with the second coil 22 facing the second main surface 20b, and the second main surface 20b of the coil unit 20 is provided with the second support member 40 in the above embodiment, it is not essential to provide the second coil 22 and second support member 40. Further, although the coil unit 20 is provided with the magnets 51 and 53, the first support member is provided with the magnet 52 in the above embodiment, and the device body 10 is provided with the magnet 54, it is not essential to provide the magnets 51 to 54.

The technology according to the present disclosure includes the following configuration examples, but not limited thereto.

A wireless power transmission device according to the present disclosure includes a coil unit, a first coil, and a first support member. The coil unit has first and second main surfaces and configured to be movable between a first position as a laid position of the first main surface and a second position as an erected position of the first main surface. The first coil is housed in the coil unit so as to face the first main surface. The first support member has a facing surface disposed separated from the first main surface by a first distance when the coil unit is at the second position.

With the above-described configuration, there can be achieved a highly convenient wireless power transmission device capable of responding to both charging in a flatbed position and charging in a vertical position.

The wireless power transmission device according to the present disclosure may further include a second coil housed in the coil unit so as to face the second main surface and a second support member fixed to the coil unit and having a facing surface disposed separated from the second main surface by a predetermined second distance when the coil unit is at the second position, and the second support member may move in conjunction with the coil unit. With this configuration, it is possible to perform double-sided charging in which, in a state where the coil unit is at the second position, two devices to be charged are vertically set on the respective first and second main surface sides and charged simultaneously.

The wireless power transmission device according to the present disclosure may further include a conductor disposed between the first and second coils, a first magnetic sheet disposed between the first coil and the conductor, and a second magnetic sheet disposed between the second coil and the conductor. This makes it possible to prevent mutual interference between the first and second coils to thereby achieve stable charging of a plurality of devices to be charged. Further, charging efficiency of the first and second coils can be improved.

In the wireless power transmission device according to the present disclosure, a distance between the first and second main surfaces of the coil unit may be smaller than the first and second distances. This can reduce the size and weight of the coil unit as a movable part.

In the wireless power transmission device according to the present disclosure, the first and second coil may each be constituted by a planar coil having a shape with different dimensions in the vertical and horizontal directions in a plan view and may each be housed in the coil unit such that the longitudinal direction thereof is perpendicular to the normal direction of the first and second main surfaces and is directed to a direction perpendicular to an erected direction in a state where the coil unit is at the second position. This can suppress reduction in charging efficiency even if a device to be charged shifts in position.

In the wireless power transmission device according to the present disclosure, in a state where the coil unit is at the second position, the height of the center position of each of the first and second coils may be higher than the height of a leading end portion of the second support member in an erected direction. With this configuration, when a device to be charged is set in the first support member, the center thereof is brought close to the center of the first coil, so that it is possible to perform efficient charging while stably holding the device to be charged.

In the wireless power transmission device according to the present disclosure, the first support member may have an elastic member by which the first distance can be changed, and the second support member may have an elastic member by which the second distance can be changed. By using such an elastic member, it is possible to respond to various devices to be charged of different thicknesses to thereby perform stable and efficient charging without involving a change in the transmitting/receiving distance.

In the wireless power transmission device according to the present disclosure, the coil unit may have a first magnet on the first main surface side thereof, and the first support member may have a second magnet positioned opposite to the first magnet when the coil unit is at the second position. Thus, attraction force is generated between the first and second magnets when the coil unit is at the erected position, so that an erected position of the coil unit can be made stable.

In the wireless power transmission device according to the present disclosure, a plurality of the first magnets may be provided in the coil unit and may be disposed close to both end sides of the coil unit in a direction perpendicular to the normal direction of the first and second main surfaces of the coil unit and in a direction perpendicular to the erected direction in a state where the coil unit is at the second position than to the center of the coil unit in the same direction. This suppresses influence on a magnetic field generated from the first coil.

The wireless power transmission device according to the present disclosure may further include a device body having a housing space capable of housing a part of the coil unit and the second support member when the coil unit is at the first position. This prevents the surface on which a device to be charged is placed from having a level difference when the device is charged in a flatbed position, thus achieving stable charging.

In the wireless power transmission device according to the present disclosure, the device body may house therein a drive circuit for driving the first and second coils as a power transmission coil. This can reduce the size and weight of the coil unit as a movable part.

In the wireless power transmission device according to the present disclosure, the second support member may have a third magnet on the side opposite to the second main surface of the coil unit, and the device body may have a fourth magnet which is disposed at a position opposite to the third magnet when the coil unit is at the first position. In this case, the third and fourth magnets may be disposed with polarities repelling each other. When the third and fourth magnets are disposed with polarities attracting each other, it is possible to make the laid position stable and to prevent unintended erection of the coil unit, thus stabilizing a state where the coil unit is folded. When the third and fourth magnets are disposed with polarities repelling each other, repelling force is generated between the third and fourth magnets during the operation of folding the coil unit 20 from the erected position to the laid position to thereby prevent damage to the coil unit due to contact with the device body.

What is claimed is:

1. A wireless power transmission device comprising:
a coil unit having first and second main surfaces and configured to be movable between a first position as a laid position of the first main surface and a second position as an erected position of the first main surface;
a first coil housed in the coil unit so as to face the first main surface; and
a first support member having a facing surface disposed separated from the first main surface by a first distance when the coil unit is at the second position.

2. The wireless power transmission device according to claim 1 further comprising:
a second coil housed in the coil unit so as to face the second main surface; and
a second support member fixed to the coil unit and having a facing surface disposed separated from the second main surface by a predetermined second distance when the coil unit is at the second position, wherein
the second support member moves in conjunction with the coil unit.

3. The wireless power transmission device according to claim 2 further comprising:
a conductor disposed between the first and second coils;
a first magnetic sheet disposed between the first coil and the conductor; and
a second magnetic sheet disposed between the second coil and the conductor.

4. The wireless power transmission device according to claim 2, wherein a distance between the first and second main surfaces of the coil unit is smaller than the first and second distances.

5. The wireless power transmission device according to claim 2, wherein
each of the first and second coil is constituted by a planar coil having a shape with different dimensions in the vertical and horizontal directions in a plan view, and is housed in the coil unit such that the longitudinal direction thereof is perpendicular to the normal direction of the first and second main surfaces and is directed to a direction perpendicular to an erected direction in a state where the coil unit is at the second position.

6. The wireless power transmission device according to claim 2, wherein,
in a state where the coil unit is at the second position, the height of the center position of each of the first and second coils is higher than the height of a leading end portion of the second support member in an erected direction.

7. The wireless power transmission device according to claim 2, wherein,
the first support member has an elastic member by which the first distance can be changed, and
the second support member has an elastic member by which the second distance can be changed.

8. The wireless power transmission device according to claim 2, wherein,
the coil unit has a first magnet on the first main surface side thereof, and
the first support member has a second magnet positioned opposite to the first magnet when the coil unit is at the second position.

9. The wireless power transmission device according to claim 8, wherein,
a plurality of the first magnets is provided in the coil unit and is disposed close to both end sides of the coil unit in a direction perpendicular to the normal direction of the first and second main surfaces of the coil unit and in a direction perpendicular to an erected direction in a state where the coil unit is at the second position than to the center of the coil unit in the same direction.

10. The wireless power transmission device according to claim 2 further comprising a device body (a fourth member) having a housing space capable of housing a part of the coil unit and the second support member when the coil unit is at the first position.

11. The wireless power transmission device according to claim 10, wherein,
the device body houses a drive circuit for driving the first and second coils as a power transmission coil.

12. The wireless power transmission device according to claim 10, wherein,
the second support member has a third magnet on the side opposite to the second main surface of the coil unit, and
the device body has a fourth magnet which is disposed at a position opposite to the third magnet when the coil unit is at the first position.

13. The wireless power transmission device according to claim 12, wherein,
the third and fourth magnets are disposed with polarities repelling each other.
